(19) United States
(12) Patent Application Publication
(10) Pub. No.: US 2014/0225926 A1
(43) Pub. Date: Aug. 14, 2014

(54) METHOD AND SYSTEM FOR GENERATING AN IMAGE AS A COMBINATION OF TWO EXISTING IMAGES

(71) Applicant: Christian Mathers, Oxford (GB)

(72) Inventor: Christian Mathers, Oxford (GB)

(21) Appl. No.: 14/180,734

(22) Filed: Feb. 14, 2014

(30) Foreign Application Priority Data
Feb. 14, 2013 (GB) 1302583.8

(51) Int. Cl. G09G 5/14; G06T 3/40

(52) U.S. Cl. CPC G09G 5/14; G06T 3/40
USPC 345/634

(57) ABSTRACT

In a method and apparatus for generating a monochrome image representing combined aligned corresponding functional and anatomical images, the anatomical image is represented as a gradient image and is combined with the anatomical image.

### BACKGROUND OF THE INVENTION

1. Field of the Invention

The present invention concerns a method and an apparatus for generating a monochrome image representing combined, aligned corresponding functional and anatomical images.

2. Description of the Prior Art

Several modalities are known for generating medical images for patient diagnosis. Each technique is particularly sensitive to a certain type of features, and less sensitive to other features.

Anatomical imaging modalities, such as CT, MRI, NMR, provide detailed information and representations of the internal structure of a patient. FIG. 1 illustrates an example CT image, taken in the so-called XY plane, transversely through a patient. Anatomical features such as bone structure and internal organs are clearly represented.

Other imaging modalities, such as PET and SPECT (Positron Emission Tomography and Single Particle Emission Computed Tomography) enable visualization of bodily functions, typically through use of tracer which is introduced into the bloodstream of a patient. The functional imaging modality used will then detect the concentration of the tracer in the imaged regions, and will produce an image indicating the locality of the tracer. Regions of high tracer density will generally indicate high blood flow. FIG. 2 shows an example PET functional image, corresponding to the anatomical image shown in FIG. 1. As can be seen from consideration of FIG. 2, functional imaging generally does not provide any detailed indication of the body structure, and so it is difficult to interpret a functional image alone, as it is usually not clear how the image aligns with the patient's body structure.

It is therefore known for a clinician to attempt to interpret a functional image by reference to an anatomical image, to locate sites of interest, such as lesions, within a patient's body.

Several methods for doing this are known, for example “alpha blending”, where each image is made partially transparent and summed together. Alternatively, a moving “window” may be provided, in which one image is shown through the window, laid on the other image as background. In other versions, one image is employed as a color coding scheme in the second image.

Clinical instruments may only be provided with a monochrome monitor, so any interpretation aids which employ color coding will not be useful on such monitors.

### SUMMARY OF THE INVENTION

The present invention aims to provide a combined image representing aligned corresponding functional and anatomical images, in a monochrome form. The invention also provides methods for generating such images.

The above object is achieved in accordance with the present invention in a method and an apparatus for generating a combined monochrome image from aligned, corresponding functional and anatomical images, wherein, in a processor, the anatomical image is converted into a monochrome gradient image, and the functional image is combined with the gradient image in the processor, and the combined image is rendered for display.

### BRIEF DESCRIPTION OF THE DRAWINGS

FIG. 1 shows an example anatomical image.

FIG. 2 shows a corresponding example functional image.

FIG. 3A shows a combined monochrome image according to an embodiment of the present invention, representing a combination of the images of FIG. 1 and FIG. 2.

FIGS. 3B-3C show further combined monochrome images according to embodiments of the present invention.

FIG. 4 shows a flow chart of a method according to an embodiment of the invention.

FIG. 5 schematically illustrates a system of the present invention, implemented as a suitably programmed computer.

### DESCRIPTION OF THE PREFERRED EMBODIMENTS

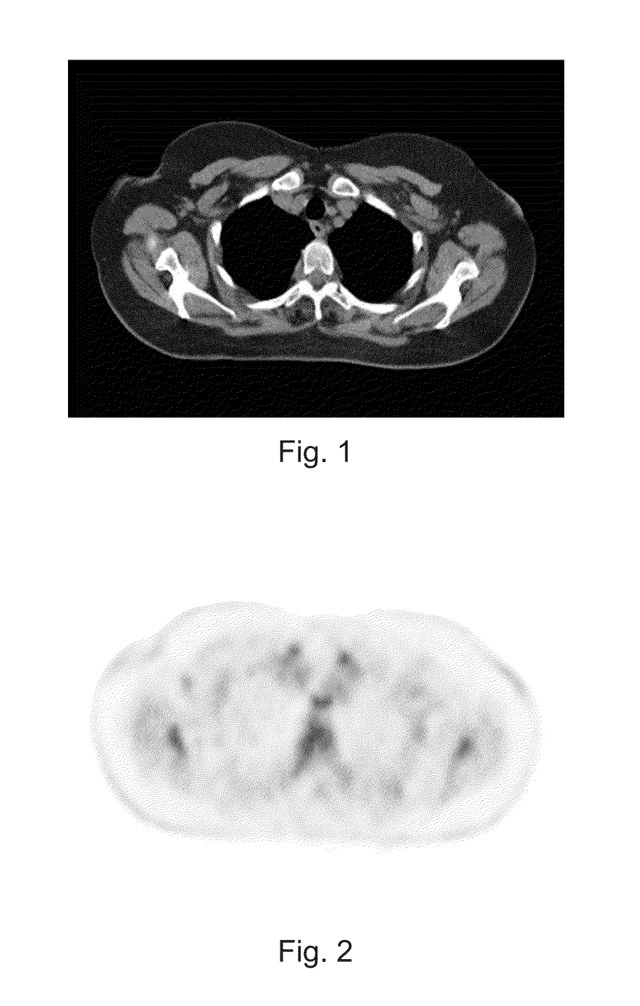

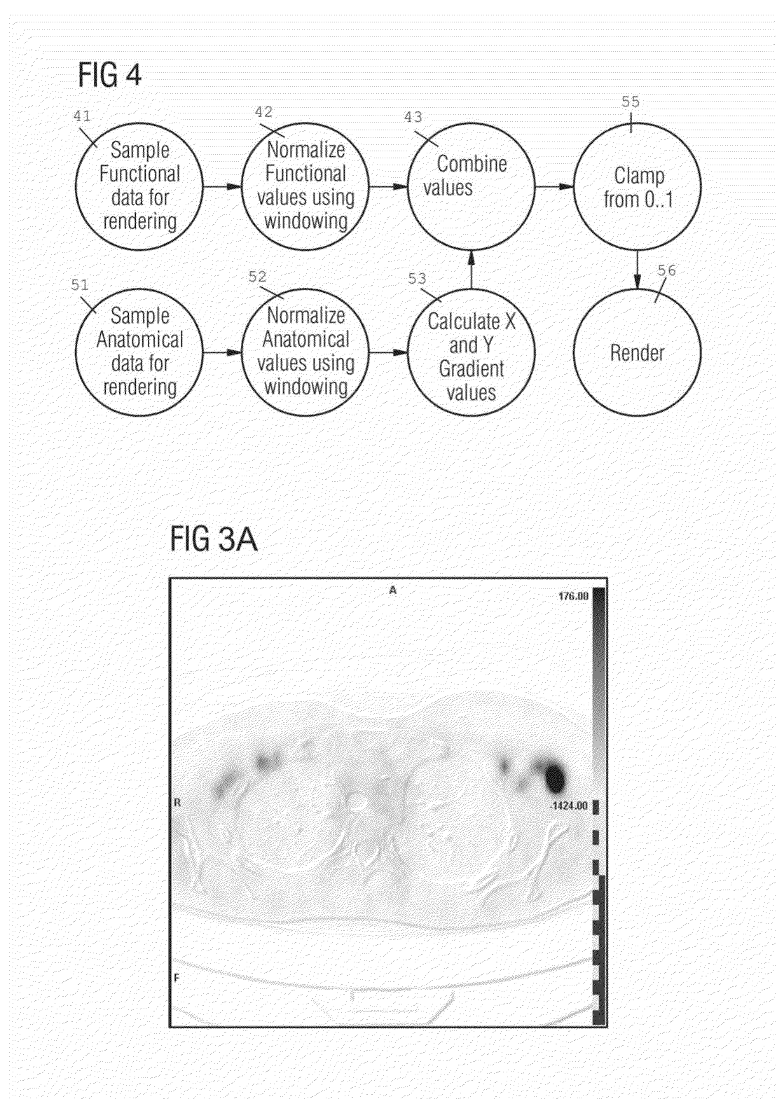

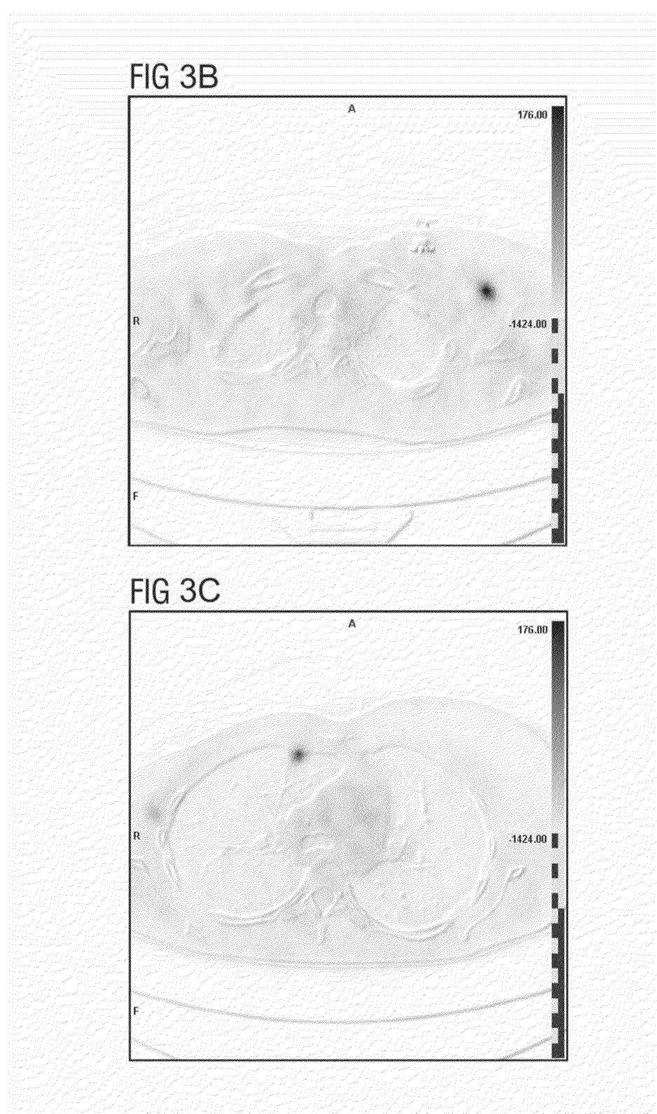

FIG. 3A shows an image according to an embodiment of the present invention. This image shows a combination of the information from the anatomical image of FIG. 1 and the functional image of FIG. 2. It combines both sets of data to provide a clear monochrome image that allows a user to view the functional image data without unnecessary clutter from the anatomical image, and for the resulting combined image to be clearly displayed on a monochrome monitor.

The image of the invention, as shown in FIGS. 3A-3C, results from a combination of a gradient image of the anatomical data combined with an inverted functional image data set: “inverted” because, in these embodiments, a dark region represents a high count, representing a high density of tracer. Conventionally, a high concentration of tracer is represented by a bright region. In other embodiments, the functional data set may not be inverted. It may even be possible for a user to switch between inverted and non-inverted versions of the image when viewing.

According to a feature of the present invention, the anatomical image is converted to a gradient image. Such a gradient image then emphasises transitions from one tissue type to another. Considering each pixel in the image of FIG. 1, taking a line of pixels in the x-direction, the gradient at the particular pixel (x,y) in the x-direction may be represented as

ΔAnatₓ=Im_{(x,y)}−Im_{((x-1),y)} [1]

Where Im(ₓ,_{y}) represents the monochrome value of the pixel (x,y) in the anatomical image, and ΔAnatₓ represents the gradient at the pixel (x,y) in the x-direction.

Similarly, taking a line of pixels in the y-direction, the gradient at the particular pixel (x,y) in the y-direction may be represented as

ΔAnat_{y}=Im_{(x,y)}−Im_{(x,(y-1))} [2]

Where ΔAnat_{y} represents the gradient at the pixel (x,y) in the y-direction.

The value Gr_{(x,y)} of the (x,y) pixel in the gradient image formed from the anatomical image by the method described above may therefore be

Gr_{(x,y)}=1.0+ΔAnatₓ+ΔAnat_{y}. [3]

Where the 1.0 term is added in to ensure that a positive value is returned for Gr_{(x,y)} which can be represented in a display scale value range, for example 0 to 1.

The functional image provided, for example, by PET data may have a value for pixel (x,y) of Func_{(x,y)}. If, as described above, the functional image is inverted, then the monochrome value InvFunc_{(x,y)} of each pixel in the inverted functional image will be:

InvFunc_{(x,y)}=1.0−Func_{(x,y)} [4]

Where the 1.0 term is added to ensure that a positive value is returned for InvFunc(ₓ,_{y}) which can be represented in a display scale value range, for example 0 to 1.

In a preferred embodiment of the invention, the two component images are multiplied together in a pixelwise fashion, such that each pixel of the resultant image has a value out_{(xy)} given by the product of the values in the corresponding pixel of the inverted functional image and the gradient image:

out_{(xy)}=Inv Func_{(x,y)}. Gr_{(x,y),} or [5]

out_{(xy)}=(1.0−Func_{(x,y))}(1.0+ΔAnatₓ+ΔAnat_{y}) [6]

Preferably, before the resultant image is rendered for viewing, it should be normalized. That is, to allow optimal clarity, the range of pixel values should be scaled to cover the full range of monochrome intensities which may be displayed on the monitor to be used. Assuming that the displayable intensities may be represented by a display scale of 0 to one, the normalization applied should ensure that the lowest intensity to be displayed should correspond to a display scale value of 0 and the highest intensity to be displayed should correspond to a display scale value of 1. This may be achieved by a linear scaling of pixel values to display scale values; or a logarithmic scaling of pixel values to display scale values. A combination or linear and logarithmic scaling may be used, whereby values at a lower or upper end of the range of pixel values may be scaled logarithmically to display scale values, while values in the centre of the range are scaled linearly to display scale values. Alternatively, or in addition, the range of values may be cropped: all pixel values below a defined “minimum” may be assigned a value display scale value of 0, while all pixel values above a defined “maximum” may be assigned a value display scale value of 1. These various scaling methods may be combined as appropriate. A user may be able to adjust the scaling used when viewing a combined image.

In addition to this scaling prior to rendering for display, the respective gradient and functional images are preferably each separately normalized before they are combined, for example according to expression [5] or [6] above. In each case, the pixel values within each image are scaled by an appropriate operation, such as one of the scaling operations described above, to extend over a determined range, such as 0 to 1. Preferably, both images are scaled to the same range. In this way, both images should be clear, but when combined, neither image will cause “wash out” of the other.

Rather than working with complete images, such as the transverse sections shown in FIGS. 1-3C, a windowing operation may be applied. In such cases, a region of interest (ROI) is defined within an image by a user. Most simply, the ROI is a rectangle, although it could be circular or elliptical, for example. It may have a size and shape determined by a user, or may have a size and shape determined by a rendering system. Typically, the user will be able to move the window defining the ROI over the whole image. Preferably, in such arrangements, each image will be normalized within the window. That is, at least that part of each image which appears within the window is scaled by any suitable method, for example any of the methods discussed above, so that the pixel values of the image within the region extend over a full display scale value range, for example 0 to 1. Similar scaling should be applied within the window in both images, so that the ROI defined by the window in each image includes pixels extending over the full range of the display value scale. In such arrangements, the user may move the window around in the resultant image, defining a varying ROI. If the scaling is applied to the while of each image, features will become brighter and darker in the combined image as the window moves around and the scaling applied varies with the content of the window.

Once the combined image is generated, for example according to equation [5] or [6], the combined image is itself scaled, so that the monochrome image data is scaled to extend across a full display scale value range, for example 0 to 1. Such scaling may be performed by any suitable method, for example any of the scaling methods described above.

In the illustrated embodiments of FIGS. 3A-3C, the gradient image contains representations of positive and negative gradients. Such arrangements may be referred to as vector gradients. Positive gradients show up a brighter than the surrounding region, while negative values show up as darker than the surrounding region. The effect is similar to one of light falling on a textured surface at a shallow angle, and provides an intuitive understanding of the gradient representation, which does not significantly interfere with the clarity of the representation of the functional data.

Alternatively, some embodiments of the present invention may use modulus gradients, where no account is taken of the direction of the gradient. In such arrangements, all gradient regions will show up as darker than the surrounding region; alternatively, the conversion into a gradient image may be performed such that all gradient regions will show up as lighter than the surrounding region. The borders will then simply represent edges of the respective anatomical features.

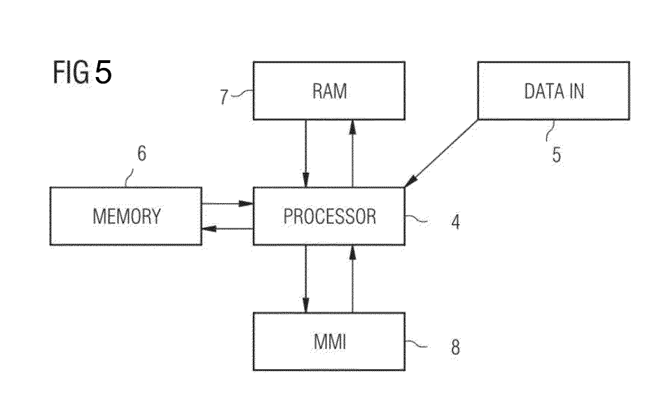

FIG. 4 represents a schematic flow chart of a method of forming a combined image according to an embodiment of the invention.

At step 41, a required part of a functional data set is sampled, representing the functional image such as illustrated in FIG. 2.

Similarly, at step 51, a required part of an anatomic data set is sampled, representing the anatomic image such as illustrated in FIG. 1.

At step 42, the region of interest ROI within the functional data set is normalized. The “window” may be the complete image, or a subset of it if a windowing technique is used. The pixel values of the whole image data sample are scaled such that the pixel values within the selected window, or the complete image data sample when no window is selected, extend over a full display scale value range, for example 0 to 1.

Similarly, at step 52, the region of interest ROI within the anatomical data set is normalized. The “window” may be the complete image, or a subset of it if a windowing technique is used. The pixel values of the whole image data sample are scaled such that the pixel values within the selected window, or the complete image data sample when no window is selected, extend over a full display scale value range, for example 0 to 1.

At step 53, the anatomical image is converted into a gradient image, for example as described above with reference to expressions [1]-[3].

At step 43, the two normalized images are combined pixelwise; that is to say, each monochrome pixel value in the resultant combined image results from a combination of the monochrome values of the corresponding pixel in the anatomical gradient image and the functional image, for example according to equation [5] or [6].

The combined image is then normalized (or “clamped”) such that the monochrome pixel values in the normalized combined image extend over a full display scale value range, for example 0 to 1, within the selected window or ROI.

Finally, the normalized combined image is rendered for display at step 56. As the present invention produces monochrome images, a monochrome monitor may be used for display of the normalized combined image. The monochrome viewing may allow a higher resolution display than would be available on a color monitor of the same size.

In use, the complete combined image may be displayed, with a window which may be moved around the image by a user. The scaling of the functional image, the gradient anatomical image and the combined image will vary according to the content of the window.

A user may be invited to select normalizing functions for the functional image, the gradient anatomical image and the combined image while the combined normalized image is being viewed. Similarly, the user may be invited to vary parameters relating to the gradient image derivation from the anatomical image data set.

One embodiment of an aspect of the invention can provide a media device storing computer program code adapted, when loaded into or run on a computer, to cause the computer to become apparatus, or to carry out a method, according to any of the above embodiments.

Referring to FIG. 5, certain embodiments of the invention may be conveniently realized as a computer system suitably programmed with instructions for carrying out the steps of the methods according to the invention.

For example, a central processing unit 4 is able to receive data representative of medical scan data via a port 5 which could be a reader for portable data storage media (e.g. CD-ROM); a direct link with apparatus such as a medical scanner (not shown) or a connection to a network.

For example, in an embodiment, the processor performs such steps as converting the anatomical image into a monochrome gradient image; combining the functional image with the gradient image; and rendering the combined image for display.

Software applications loaded on memory 6 are executed to process the image data in random access memory 7.

A Man-Machine interface 8 typically includes a keyboard/mouse/screen combination, which allows user input such as initiation of applications and a screen on which the results of executing the applications are displayed.

The present invention accordingly provides images, methods for producing images and system for combining images for improved visualization. It does not affect the reconstruction of acquired image data, but rather provides improved rendering for visualization, particularly useful when applied to monochrome visualization. This improved rendering preferably includes fusion of two imaging modalities to provide anatomical reference locations to functional imaging data, by converting an anatomical image into a gradient image and combining it with a functional image. The combination may be achieved with a multiplication step followed by a normalization. The proposed combination allows a user to see the relationship between features at corresponding positions in the original images, and thereby to view the relationship between the datasets used to generate the two images. The present invention provides rendering of two sets of data such that a user can simultaneously spatially correlate regions in one data to the other.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for generating a combined monochrome image from aligned corresponding functional and anatomical images, comprising the steps of:
in a processor, converting the anatomical image into a monochrome gradient image;
in said processor, combining the functional image with the gradient image; and
in said processor, rendering the combined image for display, including making an electronic signal representing the combined image available at an output of the processor.

2. A method according to claim 1 wherein the gradient image is produced with vector gradient representation.

3. A method according to claim 1 wherein the gradient image is produced with modulus gradient representation.

4. A method according to claim 1 wherein the functional image is inverted before the combining step.

5. A method according to claim 1 wherein pixel values of the gradient image are normalized by scaling and/or are cropped to a display scale value range before the combining step.

6. A method according to claim 1 wherein pixel values of the functional image are normalized by scaling and/or are cropped to a display scale value range before the combining step.

7. A method according to claim 1 wherein pixel values of the combined image are normalized by scaling and/or are cropped to a display scale value range before the rendering step.

8. A method according to claim 1 comprising forming the combining step by multiplying the functional and gradient images together in a pixelwise fashion, such that each pixel of the combined image has a value given by the product of the values of the corresponding pixel in the functional image and the corresponding pixel in the gradient image.

9. A method according to claim 1, further comprising performing a windowing operation via an interface of the processor, wherein a region of interest (ROI) is defined within an image by a user, and each of the functional, gradient and combined images are normalized within the window, so that the ROI defined by the window in each image includes pixels extending over the full range of a display value scale.

10. A method according to claim 8 wherein a user moves the window over the combined image, defining a varying ROI.

11. An image processing apparatus comprising:
a computerized processor;
a display unit in communication with said processor;
said processor being configured to convert the anatomical image into a monochrome gradient image;
said processor being configured to combine the functional image with the gradient image; and
said processor being configured to render the combined image for display, including making an electronic signal representing the combined image available at an output of the processor.

12. A non-transitory, computer-readable data storage medium encoded with programming instructions, said medium being loaded into a computerized processor and said programming instructions causing said processor to:
convert the anatomical image into a monochrome gradient image;
combine the functional image with the gradient image; and
render the combined image for display, including making an electronic signal representing the combined image available at an output of the processor.
